(19) United States
(12) Patent Application Publication
(10) Pub. No.: US 2023/0097083 A1
(43) Pub. Date: Mar. 30, 2023

(54) METHODS AND SYSTEMS FOR CROSS-WEB HEADLESS TRANSACTIONS

(71) Applicant: SHOPIFY INC., Ottawa (CA)

(72) Inventors: Mathieu PERREAULT, Mont Royal (CA); Sarah LINDSAY, Burlington (CA); John S. LEE, Waterloo (CA)

(21) Appl. No.: 17/489,482

(22) Filed: Sep. 29, 2021

(51) Int. Cl. G06Q 30/06; G06Q 20/40

(52) U.S. Cl. CPC G06Q 30/0643; G06Q 30/0633; G06Q 20/4014

(57) ABSTRACT

Disclosed herein are methods and systems for cross-web headless transactions. One method comprises in response to an interaction with a commerce object of a media element, retrieving a user identifier and metadata associated with a product depicted within the media element, the metadata indicating at least an attribute of the product, the media element displaying a graphical element indicating at least one attribute of the product retrieved from the metadata; retrieving payment data and a purchase preference based on the retrieved user identifier and metadata, the purchase preference being extracted from at least one previously completed purchase associated with the user identifier; generating a message containing transaction attributes corresponding to the payment data and the purchase preference; and transmitting the message to a server hosting the media element, wherein the message initiates a checkout process using at least one of the transaction attributes.

### TECHNICAL FIELD

This application relates generally to cooperating computer systems, and more particularly, integration of multiple electronic platforms to dynamically revise graphical user interfaces and to facilitate electronic transactions.

### BACKGROUND

In order to provide better online experience, images depicting products displayed on various websites may be linked to a merchant website, such that potential buyers can be directed to the merchant website upon interacting with the image. These conventional images contain links that may merely direct the potential buyer to the merchant website, possibly even a particular webpage for the product shown in the image. If the image is not properly linked, a potential buyer may be required to do a reverse lookup to identify the product depicted in the image and to identify the merchant. Potential buyers may be required to access the merchant website, search for, identify, and select the product, customize the product based on their preferences (e.g., by selecting appropriate size and color), and enter payment and shipping information to complete the transaction.

### BRIEF DESCRIPTION OF THE DRAWINGS

The accompanying drawings constitute a part of this specification and illustrate embodiments of the subject matter disclosed herein.

FIG. 1 shows an e-commerce platform, according to an embodiment.

FIG. 2 shows a home page of an administrator, according to an embodiment.

FIG. 3 shows components of a headless transaction system, according to an embodiment.

FIG. 4 shows execution steps for a headless transaction system, according to an embodiment.

FIGS. 5-6 show examples of dynamic revisions of graphical user interfaces by a headless transaction system, according to various embodiments.

### DETAILED DESCRIPTION

Reference will now be made to the illustrative embodiments illustrated in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one ordinarily skilled in the relevant art and having possession of this disclosure, are to be considered within the scope of the subject matter disclosed herein. The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

To address the above-described shortcomings, a headless transaction system utilizes an image (or other media element) that is associated with a commerce object. For example, the image may be linked directly to a prepopulated checkout page of a merchant website to facilitate a transaction. As a result, a user may purchase a product that is depicted in the media element upon selecting the medial element (e.g., image on a website, mobile application, and/or video streaming service). The user may expedite the purchase process using the user's preferences, such that the user may only be required to confirm the transaction without needing to navigate the website and to enter checkout information (e.g., searching for the product, adding the product to an electronic cart, inputting purchase preferences, or inputting payment information). The methods and systems described herein may be implemented as a standalone service (e.g., browser extension) or implemented via a local application (e.g., an application installed on the user's electronic device.

I. Example E-Commerce Platform

In some embodiments, the methods disclosed herein may be performed on or in association with a commerce platform, such as an e-commerce platform. Therefore, an example of a commerce platform will be described.

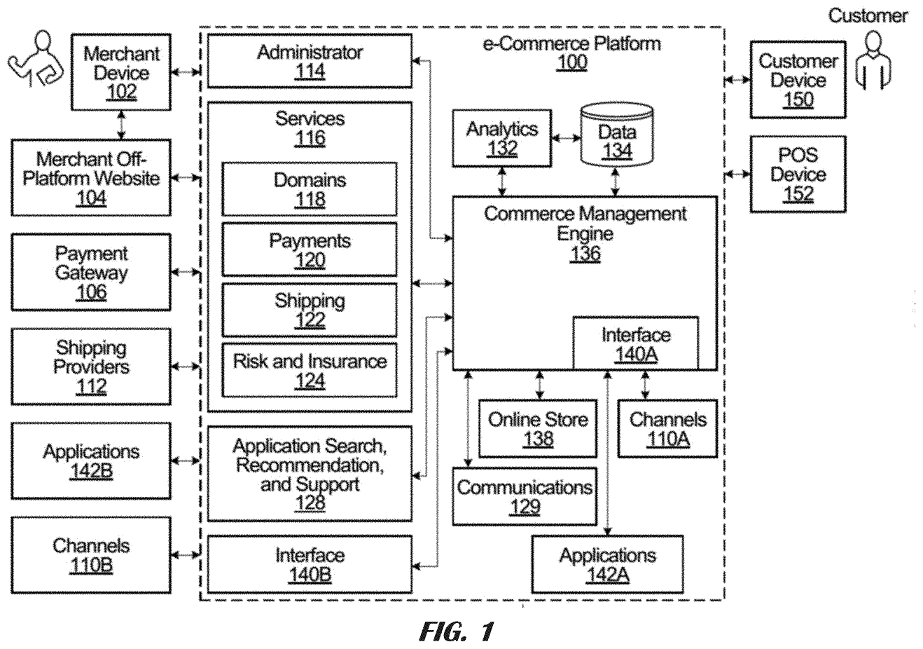

FIG. 1 illustrates an e-commerce platform 100, according to an illustrative system embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed in part or in whole through a machine that executes computer software, modules, program codes, and/or instructions on one or more processors which may be part of or external to the e-commerce platform 100. Merchants may utilize the e-commerce platform 100 for managing commerce with customers, such as by implementing an e-commerce experience with customers through an online store 138, through channels 110A-B, through POS devices 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce platform 100, or any combination thereof. A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), and the like. However, even these ‘other’ merchant commerce facilities may be incorporated into the e-commerce platform 100, such as where POS devices 152 in a physical store of a merchant are linked into the e-commerce platform 100, where a merchant off-platform website 104 is tied into the e-commerce platform 100, such as through ‘buy buttons’ that link content from the merchant off-platform website 104 to the online store 138, and the like.

The online store 138 may represent a multitenant facility comprising a plurality of virtual storefronts. In embodiments, merchants may manage one or more storefronts in the online store 138, such as through a merchant device 102 (e.g., computer, laptop computer, mobile computing device, and the like), and offer products to customers through a number of different channels 110A-B (e.g., an online store 138; a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A may be provided internal to the e-commerce platform 100 or from outside the e-commerce channel 110B. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communication facility 129 to leverage customer interactions and analytics 132 to improve the probability of sales. Throughout this disclosure the terms of online store 138 and storefront may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or to an individual merchant's storefront (e.g., a merchant's online store).

In some embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication facility 129, and the like, providing a system for reaching customers and facilitating merchant services for the real or virtual pathways available for reaching and interacting with customers.

In some embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant device 102, payment gateways 106, application developers, channels 110A-B, shipping providers 112, customer devices 150, point of sale devices 152, and the like. The e-commerce platform 100 may be implemented as a cloud computing service, a software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In some embodiments, elements of the e-commerce platform 100 may be implemented to operate on various platforms and operating systems, such as iOS, Android, on the web, and the like (e.g., the administrator 114 being implemented in multiple instances for a given online store for iOS, Android, and for the web, each with similar functionality).

In some embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150 and then the template language is replaced by data from the online store 138, such as when a theme is installed. The template and themes may consider tags, objects, and filters. The web browser (or other application) of the customer device 150 then renders the page accordingly.

In some embodiments, online stores 138 may be served by the e-commerce platform 100 to customers, where customers can browse and purchase the various products available (e.g., add them to a cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their website through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog posts or static pages and publish them to their online store 138, such as through blogs, articles, and the like, as well as configure navigation menus. Merchants may upload images (e.g., for products), video, content, data, and the like to the e-commerce platform 100, such as for storage by the system (e.g., as data facility 134). In some embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services 116, an administrator 114, and the like associated with running an on-line business, such as providing a domain service 118 associated with their online store, payment services 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

Even though the shipping services 122 is shown as a part of the e-commerce platform 100, the shipping services 122 may be implemented by a third party, such as a third party delivery or shipping service. The shipping service 122 may have a server/computer in communication with the e-commerce platform 100 where the shipping service 122 may communicate shipping requirements (e.g., shipping weight, categories, restrictions, and preferences). The e-commerce platform 100 may then use these requirements to dynamically update one or more graphical user interfaces (GUIs) discussed herein. The shipping service 122 may then receive delivery instructions from the e-commerce platform 100 and may perform the delivery using a delivery apparatus discussed herein. The shipping service 122 may also be in communication with a delivery provider's servers and/or a delivery apparatus processor, such delivery data (e.g., status of different deliveries) can be communicated to the e-commerce platform 100.

Therefore, shipping service 122 may or may not be a part of the e-commerce platform 100. For instance, the shipping service 122 may be associated with a separate entity that transmits its requirements and receives delivery instructions from the e-commerce platform 100. In another embodiment, the methods and systems discussed herein may be provided as a standalone service where the shipping service 122 utilizes the e-commerce platform 100 to dynamically customize graphical user interfaces and transmit delivery instructions and attributes back to the shipping service 122.

In a non-limiting example, the shipping service 122 represents a server of a delivery platform that utilizes a drone to deliver food. The shipping service 122 first transmits drone delivery requirements to the e-commerce platform 100, such that various graphical user interfaces are revised accordingly. When the customer's order is finalized, the e-commerce platform 100 transmits delivery data (e.g., items and address) to the shipping service 122.

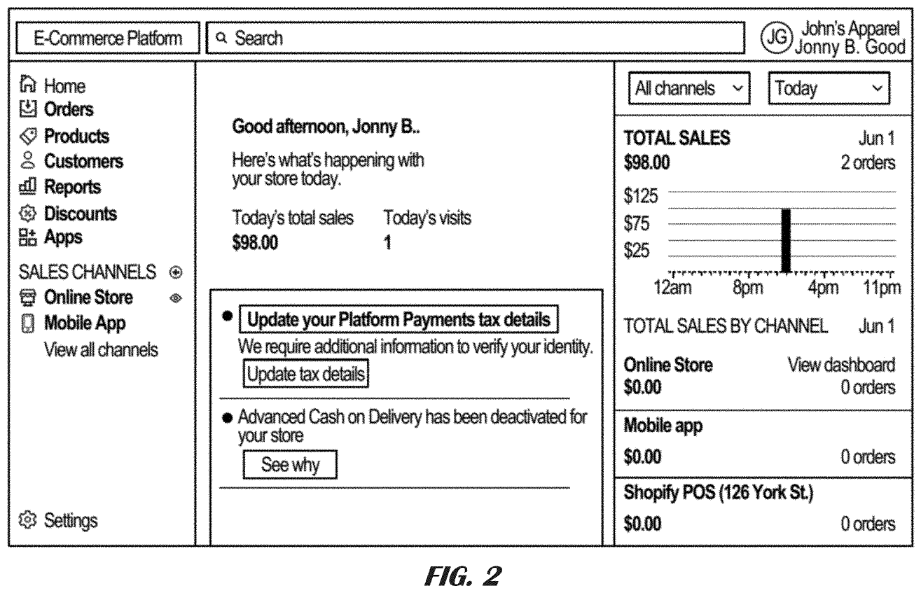

FIG. 2 depicts a non-limiting embodiment for a home page of a merchant administrator 114, which may show information about daily tasks, a store's recent activity, and the next steps a merchant can take to build their business. In some embodiments, a merchant may log in to administrator 114 via a merchant device 102 such as from a desktop computer or mobile device, and manage aspects of their online store 138, such as viewing the online store's 138 recent activity, updating the online store's 138 catalog, managing orders, recent visits activity, total orders activity, and the like. In some embodiments, the merchant may be able to access the different sections of administrator 114 by using the sidebar, such as shown on FIG. 2. Sections of the administrator 114 may include various interfaces for accessing and managing core aspects of a merchant's business, including orders, products, customers, available reports and discounts. The administrator 114 may also include interfaces for managing sales channels for a store including the online store 138, mobile application(s) made available to customers for accessing the store (Mobile App), POS devices, and/or a buy button. The administrator 114 may also include interfaces for managing applications (Apps) installed on the merchant's account; settings applied to a merchant's online store 138 and account. A merchant may use a search bar to find products, pages, or other information. Depending on the merchant device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g., via a mobile application), they may be able to view all or a subset of the aspects of their online store 138, such as viewing the online store's 138 recent activity, updating the online store's 138 catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include acquisition reports, behavior reports, customer reports, finance reports, marketing reports, sales reports, custom reports, and the like. The merchant may be able to view sales data for different channels 110A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfilled, archiving an order that is complete, and the like.

The e-commerce platform 100 may provide for a communications facility 129 and associated merchant interface for providing electronic communications and marketing, such as utilizing an electronic messaging aggregation facility for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's bank account (e.g., when using capital), and the like. These systems may have Sarbanes-Oxley Act (SOX) compliance and a high level of diligence required in their development and operation. The financial facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In some embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In some embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 1, in some embodiments the e-commerce platform 100 may be configured with a commerce management engine 136 for content management, task automation and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services, where applications 142A may be provided internal to the e-commerce platform 100 or applications 142B from outside the e-commerce platform 100. In some embodiments, an application 142A may be provided by the same party providing the e-commerce platform 100 or by a different party. In some embodiments, an application 142B may be provided by the same party providing the e-commerce platform 100 or by a different party. The commerce management engine 136 may be configured for flexibility and scalability through portioning (e.g., sharding) of functions and data, such as by customer identifier, order identifier, online store identifier, and the like. The commerce management engine 136 may accommodate store-specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion into the commerce management engine 136 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by its extension through an application programming interface (API) connection to applications 142A-B and channels 110A-B, where interfaces 140A may be provided to applications 142A and/or channels 110A inside the e-commerce platform 100 or through interfaces 140B provided to applications 142B and/or channels 110B outside the e-commerce platform 100. Generally, the e-commerce platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the e-commerce platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which require information from multiple online stores 138 to perform well. In some embodiments, rather than violating the isolation principle, it may be preferred to move these components out of the commerce management engine 136 and into their own infrastructure within the e-commerce platform 100.

In some embodiments, the e-commerce platform 100 may provide for a platform payment facility 120, which is another example of a component that utilizes data from the commerce management engine 136 but may be located outside so as to not violate the isolation principle. The platform payment facility 120 may allow customers interacting with online stores 138 to have their payment information stored safely by the commerce management engine 136 such that they only have to enter it once. When a customer visits a different online store 138, even if they've never been there before, the platform payment facility 120 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error prone for each online store 138 to be able to connect to any other online store 138 to retrieve the payment information stored there. As a result, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions/API), and the like. Merchants may be enabled to discover and install applications 142A-B through application search, recommendations, and support 128. In some embodiments, core products, core extension points, applications, and the administrator 114 may be developed to work together. For instance, application extension points may be built inside the administrator 114 so that core features may be extended by way of applications, which may deliver functionality to a merchant through the extension.

In some embodiments, applications 142A-B may deliver functionality to a merchant through the interface 140A-B, such as where an application 142A-B is able to surface transaction data to a merchant (e.g., App: “Engine, surface my app data in mobile and web admin using the embedded app SDK”), and/or where the commerce management engine 136 is able to ask the application to perform work on demand (Engine: “App, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as utilizing APIs to expose the functionality and data available through and within the commerce management engine 136 to the functionality of applications (e.g., through REST, GraphQL, and the like). For instance, the e-commerce platform 100 may provide API interfaces 140A-B to merchant and partner-facing products and services, such as including application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension or API 140A-B, help make products easy to view and purchase in a fast growing marketplace. In some embodiments, partners, application developers, internal applications facilities, and the like, may be provided with a software development kit (SDK), such as through creating a frame within the administrator 114 that sandboxes an application interface. In some embodiments, the administrator 114 may not have control over nor be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, such as for synchronizing a local database, notifying an external integration partner, and the like. Update events may enable this functionality without having to poll the commerce management engine 136 all the time to check for updates, such as through an update event subscription. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time.

In some embodiments, the e-commerce platform 100 may provide application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized by application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In some embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, integration applications, and the like. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In some embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142A-B so that the commerce management engine 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 110A-B is a place where customers can view and buy products. In some embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In some embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., ‘secret’ strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110A-B may use the commerce management engine 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In some embodiments, the payment gateway 106 may accept international payment, such as integrating with leading international credit card processors. The card server environment may include a card server application, card sink, hosted fields, and the like. This environment may act as the secure gatekeeper of the sensitive credit card information. In some embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and may track quantities for variants that have inventory tracking enabled. It may decouple product variants (a customer facing concept representing the template of a product listing) from inventory items (a merchant facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In some embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that does not provide an API connection). An API fulfillment service may trigger a third-party, where the third-party application creates a fulfillment record. A legacy fulfillment service may trigger a custom API call from the commerce management engine 136 to a third-party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

II. Example Networked Components of System

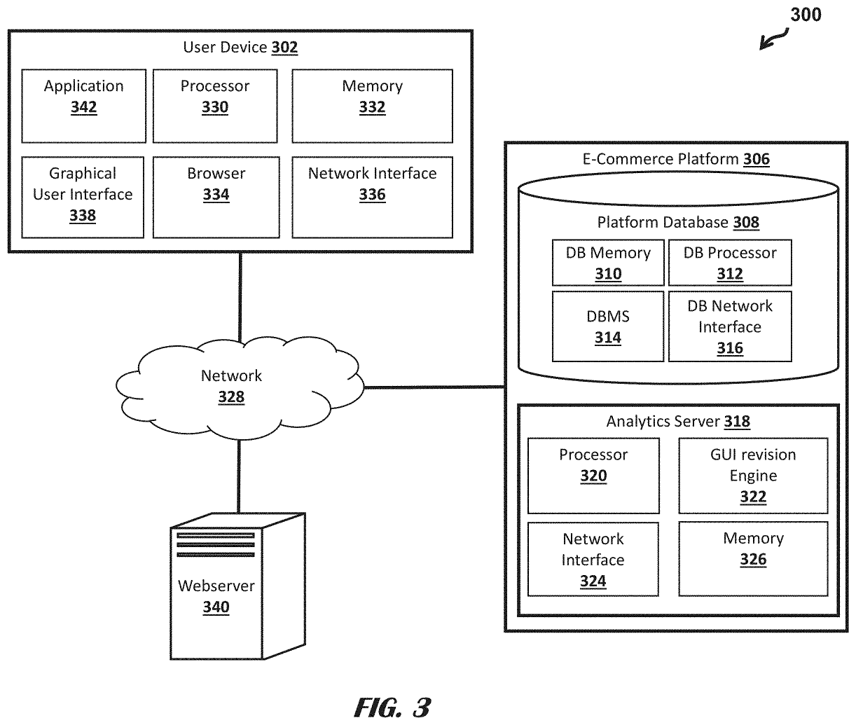

FIG. 3 illustrates components of a headless transaction system 300, according to an embodiment. The system 300 may include a user device 302 and a webserver 340 to connect with an e-commerce platform 306 via a network 328. The depicted system 300 is described and shown in FIG. 3 as having one of each component for ease of description and understanding of the example. The embodiments may include any number of the components described herein. The embodiments may comprise additional or alternative components, or may omit certain components, and still fall within the scope of this disclosure.

The network 328 may include any number of networks, which may be public or private networks. The network 328 may comprise hardware and software components implementing various network and/or telecommunications protocols facilitating communications between various devices, which may include devices of the system 300 or any number of additional or alternative devices not shown in FIG. 3. The network 328 may be implemented as a cellular network, a Wi-Fi network (or other wired or wireless local area network (LAN)), a WiMAX network (or other wired or wireless wide area network (WAN)), and the like. The network 328 may also communicate with external servers of other external services coupled to the network 328 such as servers hosting a server of a financial institution (e.g., to facilitate payment for a pending transaction).

The network 328 may include any number of security devices or logical arrangements (e.g., firewalls, proxy servers, or DMZs) to monitor or otherwise manage web traffic to the e-commerce platform 306. Security devices may be configured to analyze, accept, or reject incoming web requests from the user device 302 and/or the webserver 340. In some embodiments, the security device may be a physical device (e.g., a firewall). Additionally or alternatively, the security device may be a software application (e.g., Web Application Firewall (WAF)) that is hosted on, or otherwise integrated into, another computing device of the system 300. The security devices monitoring web traffic are associated with and administered by the e-commerce platform 306.

The user device 302 may be any electronic device comprising hardware and software components capable of performing the various tasks and processes described herein. Non-limiting examples of the user device 302 may include mobile phones, tablets, smart watches, display devices that use augmented reality (AR) or virtual reality (VR) technology, laptops, and personal computers, among others. When communicating with components of the e-commerce platform 306, the user device 302 may generate web traffic (or web session data) that is processed by or otherwise accessible to the analytics server 318 of the e-commerce platform 306. The web traffic may comprise data packets that include various types of data that can be parsed, analyzed, or otherwise reviewed by various programmatic algorithms of the analytics server 318. For instance, the web traffic data may indicate which website was accessed by a user operating the user device 302 (e.g., whether a user operating the user device 302 has accessed the website hosted by the webserver 340 or whether the user has interacted with a graphical component of the website).

In an example, a user operating the user device 302 visits a website of a merchant (e.g., a merchant's online store) hosted by the webserver 340 using the browser 334. Even though the website is described herein as a merchant's online store, it is expressly understood that the methods and systems described herein are not limited to online shopping websites. The methods and systems described herein apply to any electronic platform outputting a media element, such as any video streaming platform or any website that displays an image.

The merchant's online store may include one or more features monitored by the analytics server 318. For instance, the analytics server 318 of the e-commerce platform 306 may monitor (e.g., via the application 342) how the user interacts with various media elements displayed within the merchant's online store. As described herein, the analytics server 318 may revise one or more features displayed on the merchant's online store. The browser 334 may transmit and receive data packets in order to display various features of the merchant's online store on a GUI 338.

The merchant's online store may refer to any electronic platform that is directly or indirectly hosted by a merchant associated with the webserver 340. For instance, the merchant's online store may be a website displayed on a browser or a mobile application that is hosted (or otherwise functionally controlled) by the webserver 340 and/or the analytics server 318. In the embodiments where the merchant's online store is website, a user operating the user device 302 may execute the browser 334 (or other applications) to connect the user device 302 to the analytics server 318 and/or the webserver 340 using an IP address obtained by translating a domain name of the website. The analytics server 318 and/or the webserver 340 may execute code associated with the website and render the appropriate graphics to be presented to the GUI 338.

In some embodiments, the user device 302 may be in direct communication with the analytics server 318; for instance, via the application 342 that is installed on the user device 302. The user device 302 and/or the merchant application 342 may then execute the appropriate code to facilitate transactions and execute the methods described herein. For instance, using the application 342, a user operating the user device 302 may generate a profile and enter their payment information to facilitate transactions. As a result, the analytics server 318 may monitor the user's purchases and other online behavior to extract purchase preferences associated with the user.

Even though certain embodiments described herein describe the website as being hosted by the webserver 340, the methods and systems described herein also apply to websites associated with the webserver 340 that are hosted by a third-party webserver. Furthermore, the methods described herein are also applicable in other environments such as non-ecommerce infrastructures and system architectures. Moreover, the methods discussed herein also apply to any media element, such as a video stream presented on an electronic platform accessed by the user device 302. In another example, the image may refer to an augmented reality (AR) or virtual reality (VR) image displayed via special display devices, such as AR/VR headsets. In another example the image may be a two-dimensional or three dimensional image.

The user device 302 may be a mobile phone, tablet, gaming console, screen-less device, (e.g., virtual personal assistant device), laptop, or personal computer. The user device 302 may include a processor 330, memory 332, GUI 338, and network interface 336. An example of the GUI 338 is a display screen (which may be a touch screen), a gesture recognition system, a keyboard, a stylus, and/or a mouse. The network interface 336 is provided for communicating over the network 328. The structure of the network interface 336 will depend on how the user device 302 interfaces with the network 328. For example, if the user device 302 is a mobile phone or tablet, the network interface 336 may include a transmitter/receiver with an antenna to send and receive wireless transmissions to/from the network 328.

The user device 302 may be connected to the network 328 with a network cable. The network interface 336 may include, for example, a network interface card (NIC), a computer port, and/or a network socket. The processor 330 directly performs or instructs all of the operations performed by the user device 302. Non-limiting examples of these operations include processing customer inputs received from the GUI 338, preparing information for transmission over the network 328, processing data received over the network 328, and instructing a display screen to display information. The processor 330 may be implemented by one or more processors that execute instructions stored in the memory 332. Alternatively, some or all of the processor 330 may be implemented using dedicated circuitry, such as an ASIC, a GPU, or a programmed FPGA.

The e-commerce platform 306 is a computing system infrastructure that may be owned and/or managed (e.g., hosted) by an e-commerce service and, in some embodiments, may be the same as or similar to that described with reference to FIGS. 1-2, though this need not be the case. The e-commerce platform 306 includes electronic hardware and software components capable of performing various processes, tasks, and functions of the e-commerce platform 306. For instance, the computing infrastructure of the e-commerce platform 306 may comprise one or more platform networks (not shown) interconnecting the components of the e-commerce platform 306. The platform networks may comprise one or more public and/or private networks and include any number of hardware and/or software components capable of hosting and managing the networked communication among devices of the e-commerce platform 306.

As depicted in FIG. 3, the components of the e-commerce platform 306 include the analytics server 318 and a platform database 308. However, the embodiments may include additional or alternative components capable of performing the operations described herein. In some implementations, certain components of the e-commerce platform 306 may be embodied in separate computing devices that are interconnected via one or more public and/or private internal networks (e.g., network 328). In some implementations, certain components of the e-commerce platform 306 may be integrated into a single device. For instance, the analytics server 318 may host the platform database 308.

Furthermore, the e-commerce platform 306 may include the analytics server 318 configured to serve various functions of the e-commerce platform 306. Non-limiting examples of such functions may include webservers hosting webpages (or at least a portion of a webpage, such as the checkout portion) on behalf of merchants (e.g., merchants' online stores), security servers executing various types of software for monitoring web traffic (e.g., determining that a customer has reached a checkout page using the electronic device), and database servers hosting various platform databases 308 of the e-commerce platform 306, among others.

The e-commerce platform 306 is shown and described as having only one analytics server 318 performing each of the various functions of the e-commerce service. For instance, the analytics server 318 is described as serving the functions of executing a GUI revision engine 322. It is intended that FIG. 3 be merely illustrative and that embodiments are not limited to the description of the system 300 or the particular configuration shown in FIG. 3. The software and hardware of the analytics server 318 may be integrated into a single distinct physical device (e.g., a single analytics server 318) or may be distributed across multiple devices (e.g., multiple analytics servers 318).

For example, some operations may be executed on a first computing device while other operations may be executed on a second computing device, such that the functions of the analytics server 318 are distributed among the various computing devices. In some implementations, the analytics server 318 may be a virtual machine (VM) that is virtualized and hosted on computing hardware configured to host any number of VMs.

The platform database 308 stores and manages data records concerning various aspects of the e-commerce platform 306, including information about, for example, actors (e.g., merchants, customers, or platform administrators), electronic devices, merchant offerings (e.g., products, inventory, or services), delivery methods, various metrics and statistics, machine-learning models, merchant pages hosting merchant stores, and other types of information related to the e-commerce platform 306 (e.g., usage and/or services).

The platform database 308 may also include various libraries and data tables including detailed data needed to perform the methods described herein, such as revising the merchant's online store. For instance, the analytics server 318 may generate a data table associated with different products offered by different merchants and/or merchants' online stores. In another example, the analytics server 318 may generate a data table associated with different rules and regulations to identify cross-sell and up-sell products. The platform database 308 may also include a user profile that includes all data associated with a user account (e.g., user operating the user device 302). The user profile may include historical purchases and information inputted by the user (e.g., payment information or delivery preferences). The user profile may also include information derived and extracted based on user data included within the profile. For instance, the analytics server 318 may analyze the user's previous purchases and may extract/derive the user's preferred method of payment or shipment. The analytics server 318 may also extract/drive the user's preferred purchase attributes, such as size, style, color, and the like.

The platform database 308 may be hosted on any number of computing devices having a processor (sometimes referred to as a database (DB) processor 320) and non-transitory machine-readable memory configured to operate as a DB memory 310 and capable of performing the various processes and tasks described herein. For example, one or more analytics servers 318 may host some or all aspects of the platform database 308.

A computing device hosting the platform database 308 may include and execute database management system (DBMS) 314 software, though a DBMS 314 is not required in every potential embodiment. The platform database 308 can be a single, integrated database structure or may be distributed into any number of database structures that are configured for some particular types of data needed by the e-commerce platform 306. For example, a first database could store user credentials and be accessed for authentication purposes, and a second database could store raw or compiled machine-readable software code (e.g., HTML, JavaScript) for webpages such that the DB memory 310 is configured to store information for hosting webpages.

The computing device hosting the platform database 308 may further include a DB network interface 324 for communicating via platform networks of the e-commerce platform 306. The structure of the DB network interface 316 will depend on how the hardware of the platform database 308 interfaces with other components of the e-commerce platform 306. For example, the platform database 308 may be connected to the platform network with a network cable. The DB network interface 324 may include, for example, a NIC, a computer port, and/or a network socket. The database processor 320 directly performs or instructs all of the operations performed by the platform database 308.

Non-limiting examples of such operations may include processing queries or updates received from the analytics server 318, user device 302, and/or webserver 340, and preparing information for transmission via the platform network and/or the external networks. The database processor 320 may be implemented by one or more processors that execute instructions stored in the DB memory 310 or other non-transitory storage medium. Alternatively, some or all of the DB processor 312 may be implemented using dedicated circuitry such as an ASIC, a GPU, or a programmed FPGA.

The DB memory 310 of the platform database 308 may contain data records related to, for example, user activity, and various information and metrics derived from web traffic involving user accounts. The data may be accessible to the analytics server 318. The analytics server 318 may issue queries to the platform database 308 and data updates based upon, for example, successful or unsuccessful authentication sessions.

The analytics server 318 may be any computing device that comprises a database processor 320 with non-transitory machine-readable storage media (e.g., server memory 326) and that is capable of executing the software for one or more functions such as the GUI revision engine 322. In some cases, the server memory 326 may store or otherwise contain the computer-executable software instructions, such as instructions needed to execute the GUI revision engine 322. The software and hardware components of the analytics server 318 enable it to perform various operations that serve particular functions of the e-commerce platform 306.

For example, the analytics server 318 that serves as a webserver may execute various types of webserver software (e.g., Apache® or Microsoft IIS®). As another example, the analytics server 318 may cause the merchant's online store to be revised in accordance with the methods described herein. The analytics server 318 may either directly revise the online store or instruct the webserver 340 or any other webserver to revise the online store accordingly. It is intended that these are merely examples and not intended to be limiting as to the potential arrangements or functions of the analytics server 318. Non-limiting examples of the analytics server 318 may include desktop computers, laptop computers, and tablet devices, among others.

The analytics server 318 may execute the GUI revision engine 322 that directly or indirectly revises the GUI 338 accessed by the user operating the user device 302 (merchant's online store). For instance, the GUI revision engine 322 may transmit an instruction that causes the webserver 340 to revise one or more items displayed within the online store in accordance with the methods described herein. The location of the GUI revision engine 322 is merely an example. The GUI revision engine 322 may be executed by the analytics server 318 and/or by the user device 302 under the direction of the analytics server 318 (e.g., via the application 342). Therefore, the GUI revision engine 322 can be performed locally on a user's device or in the back-end of the system 300.

Additionally or alternatively, the GUI revision engine 322 could be provided by the e-commerce platform 306 as a separate web-based or cloud-based service. In some implementations, the GUI revision engine 322 is implemented at least in part by a user device such as the user device 302 and/or the webserver 340. Other implementations of the GUI revision engine 322 are also contemplated such as a stand-alone service to dynamically revise features of any website. While the GUI revision engine 322 is shown as a single component of the e-commerce platform 306, the GUI revision engine 322 could be provided by multiple different components that are in networked communication with the analytics server 318 executing the GUI revision engine 322.

The webserver 340 may be any server associated with a merchant hosting an online store or any other electronic platform (e.g., website displaying one or more media elements, such as images and/or videos). The webserver 340 may be any computing device hosting a website (or any other electronic platform) accessible to users (e.g., operating the user device 302) via the network 328. The webserver 340 may include a processing unit and non-transitory machine-readable storage capable of executing various tasks described herein. The processing unit may include a processor with a computer-readable medium, such as a random access memory coupled to the processor. Non-limiting examples of the processor may include a microprocessor, an application specific integrated circuit, and a field programmable object array, among others. Non-limiting examples of the webserver 340 may include workstation computers, laptop computers, server computers, laptop computers, and the like. While the system 300 includes a single webserver 340, in some embodiments the webserver 340 may include a number of computing devices operating in a distributed computing environment.

The webserver 340 may be configured to interact with one or more software modules of the same or different types depicted within the system 300. For instance, the webserver 340 may execute software applications configured to host an electronic platform which may generate and serve various webpages to the user device 302. The electronic platform may also embed various GUIs 338 generated by the analytics server 318 (e.g., halos associated with different images). The online store hosted by the webserver 340 may be configured to require user authentication based upon a set of user authorization credentials (e.g., username, password, biometrics, cryptographic certificate, and the like). These functionalities may also be executed by the analytics server 318 on behalf of the webserver 340.

The system 300 allows for the analytics server 318 to utilize an image (or other media element) to facilitate a transaction. As a result, a user (operating the user device 302) may purchase a product upon selecting an image on a website, mobile application, video streaming services, or the like that is hosted by the webserver 340. The user may expedite the purchase process using the user's preferences, such that the user may only be required to confirm the transaction without other navigation via the website (e.g., searching for the product) or without needing to input their purchase preferences. For instance, the user may not be required to select their desired size, style, and/or color, as these attributes are automatically selected for the user based on the user's purchase preferences extracted from the user's previous purchases. The methods described herein may be implemented as a standalone service (e.g., browser extension) or implemented via a local application (e.g., application 342).

III. Example Methods of Performing Cross-Web Headless Transactions

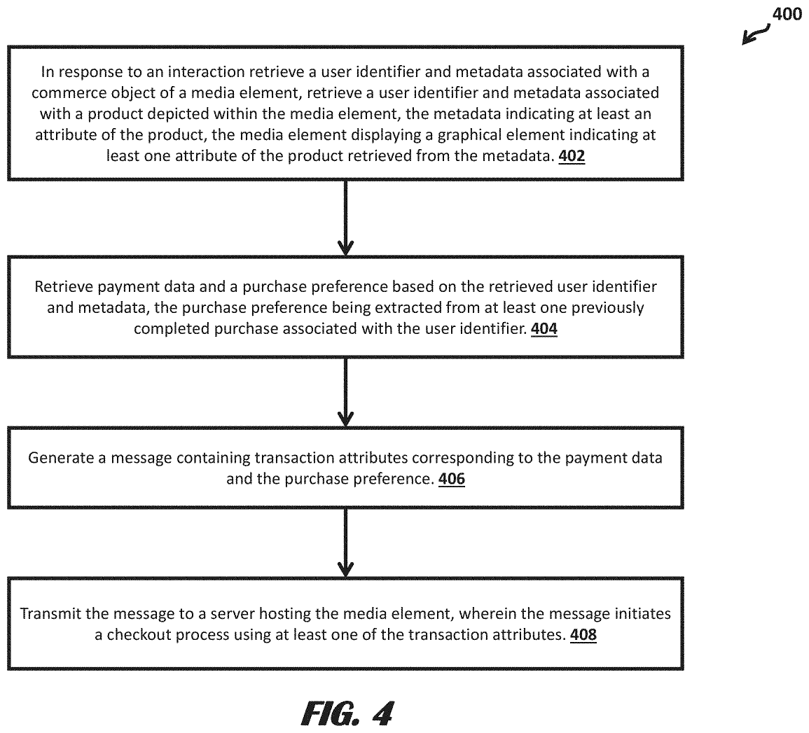

FIG. 4 illustrates a flowchart depicting operational steps for a headless transaction system, in accordance with an embodiment. The method 400 describes how a server, such as the analytics server described in FIG. 3, can facilitate a transaction based on a user's unique characteristics. Certain aspects of the method 400 is described in the context of revising visual attributes of the GUI associated with a merchant's website. Therefore, as described herein, the GUI may refer to any website (e.g., a merchant's online store, an application (e.g., mobile application) for the merchant's online store, or any other website displaying a media element that depicts a product that can be purchased by users).

Even though the method 400 is described as being executed by the analytics server, the method 400 can be executed by any server and/or locally within a user's trusted device (e.g., user device discussed in FIG. 3). Additionally or alternatively a server can execute the method 400 in other computer environments (other than the environments depicted in FIGS. 1-3). For instance, the method 400 can be executed by a server providing SaaS in a non-commerce infrastructure for any electronic platform. For instance, a webserver hosting a video streaming service can utilize the methods provided by the analytics server to allow the user to purchase one or more products depicted within a video displayed on the user's electronic device (e.g., a user may purchase a product depicted within a movie).

Additionally or alternatively, the method 400 may be executed by a webserver hosting a GUI (e.g., a mobile application) and executing various methods described herein. Additionally or alternatively, the method 400 may be executed by a server hosting an application configured to display a GUI and acting as the analytics server by executing various GUI revision methods described herein. Furthermore, other configurations of the method 400 may comprise additional or alternative steps, or may omit one or more steps altogether.

At step 402, in response to an interaction with a commerce object of a media element, the analytics server may retrieve a user identifier and metadata associated with a product depicted within the media element, the metadata indicating at least an attribute of the product, the media element displaying a graphical element indicating at least one attribute of the product retrieved from the metadata. When the analytics server detects that the user has interacted with the media element (or a graphical indicator associated with the media element), the analytics server may receive or retrieve a user identifier (UID) associated with the user and metadata associated with a product depicted within the media element. The analytics server may use the UID to access a user profile and retrieve data (e.g., purchase preferences) of the user. The analytics server may use the metadata to identify the product.

The analytics server may receive the metadata using at least one of multiple methods. For instance, when a user interacts with a commerce object, the webserver may either directly transmit the metadata to the analytics server and/or may direct the analytics server to a data repository that includes metadata (or other data) associated with the product.

Using an application installed on the user device, via a browser extension, or via communicating with a webserver that is hosting a website, the analytics server may receive an indication that a user has interacted with a media element outputted by the website. For instance, the analytics server may receive an indication that the user has clicked on an image or hovered over an image displayed on a website. In another example, an application installed on the user device may transmit an indication that a user is interacting with a media element, such as clicked on a video streaming on a website or application (e.g., the user has paused the video and clicked on a product depicted within the paused frame). The interaction with the media element may be limited to a particular region of the media element (e.g., a region depicting a particular product in a still image or video) or may include the entire media element.

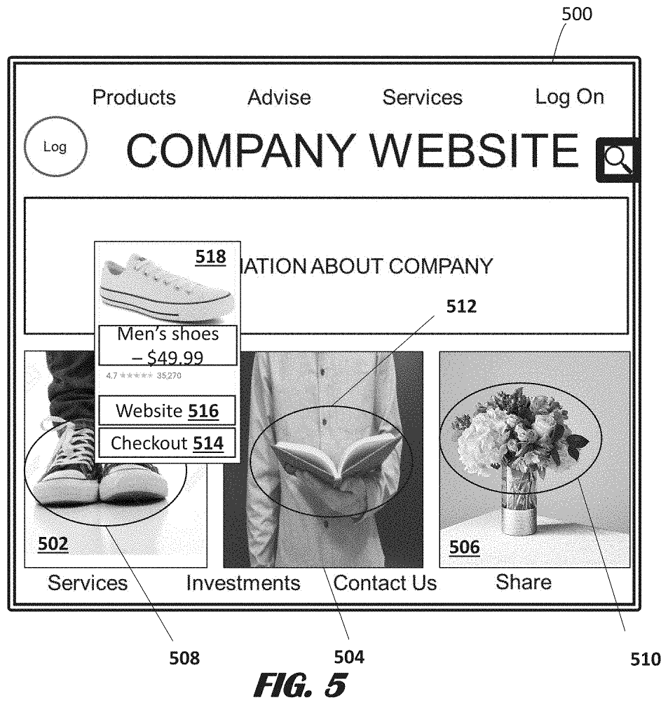

As will be described below, in some configurations, the analytics server may display a graphical element for the product depicted within a media element. The graphical element may be a halo that highlights the product or an indicator (e.g., a shopping bag, halo, a star, or a logo) that indicates the presence of a commerce object in the media element. In those embodiments, the analytics server may receive an indication that the user has interacted with the graphical element. The user may interact with the graphical element to view data associated with the depicted product. For instance, as depicted in FIG. 5, the user may hover over a halo displayed near or around the depiction of the product within the media element to view data associated with the product.

The metadata, as used herein, refers to any data that can be analyzed to identify the product depicted within the media element, such as product name, merchant offering the product, price, available colors, sizes, styles, and/or any other information associated with the product. The analytics server may also determine visual attributes of the product depicted within the media element. For instance, using the metadata received, the analytics server may determine that the product depicted within an image corresponds to men's shoes of a particular style (e.g., two-tone shoes). In some embodiments, the analytics server may also identify whether the image is displaying a blue pair of shoes or a yellow pair of shoes. That is, the analytics server may determine all the available colors associated with the pair of shoes and the color of the actual pair of shoes depicted within the media element.

The media element may be associated with a commerce object. For instance, the webserver may have linked the image to code representing a purchase path for customers to purchase the product associated with (e.g., depicted within) the media element. The commerce object may represent a portion of the code of the website (or other electronic platform), such as the JavaScript or HTML, code that resides in a data repository associated with the webserver, that includes information associated with the media element. In an example, the commerce object may indicate details regarding a product associated with (or depicted within) a media element rendered on a website. The commerce object may also direct the analytics server to (e.g., transmit to the analytics server) a unique identifier associated with the product depicted within the image. The unique identifier may direct the analytics server to more information (e.g., metadata) about the product.

In an example, the unique identifier may be a part of the URL linked to (or otherwise associated with) the media element or the purchase path. As a result, the analytics server may parse the URL to determine the unique identifier of the product. In another example, the unique identifier may map to another webpage that identifies the product or includes information about the product (e.g., style and color of the shoes). In another example, the analytics server may query a database (e.g., internal or external) using the unique identifier to identify information associated with the product. For instance, the unique identifier may map to a SKU of the product and the analytics server may determine pertinent attributes of the product by retrieving information associated with the SKU. In yet another example, the commerce object may automatically transmit metadata associated with the product to the analytics server.

In some configurations, the commerce object may instruct the webserver to initiate a dependent action, such as a checkout session or directing the user to a secondary webpage. For instance, the commerce object may indicate that the webserver should direct the user to a second webpage where the user can input various attributes of the product depicted within the image (e.g., indicate size and color) when the user interacts with the image. In this example, the image is linked to a second webpage.

The analytics server may perform the method 400 regardless of whether the media element is linked to another webpage. For instance, if an image is already linked to a checkout page, as will be described below, the analytics server may transmit pertinent information to the webserver, such that the webserver can facilitate the transaction. However, even if the image is not linked to a checkout page, the analytics server may instruct the webserver to initiate a checkout process (e.g., add the product the user's cart or direct the user to a checkout page). In some instances, once a checkout process is initiated, the user may only need to confirm the transaction (e.g., by clicking a “confirm” or “purchase” button). Therefore, in some embodiments, the analytics server may only need to receive (via the commerce object or any other method discussed herein) metadata associated with the product depicted within a media element.

In some embodiments, the analytics server may identify the UID based on a received identifier token. For instance, responsive to the user interacting with the commerce object embedded within or otherwise associated with the media element, the local application, the browser extension, and/or the webserver may transmit an identifier token (or any other form of an electronic message) to the analytics server. The identifier token may include an encrypted UID, such that only the analytics server can access the UID. By transmitting an identifier token (that has been encrypted) instead of transmitting the UID (e.g., user's login credentials), the analytics server may ensure that the user's data is not inappropriately accessed by other parties and the user's online activity is not inappropriately shared with other parties.

The UID may be a unique identifier associated with the user, which may be utilized to recognize the user interacting with the media element. For instance, the user may have provided login credentials (e.g., name, UID, email address, phone number, mailing address, or other personally-identifiable information) when generating a user profile associated with the analytics server (e.g., using the application). The commerce object may transmit one or more of these login credentials or other credentials stored by the browser or application.

The UID may also refer to a unique identifier of the user device, such as an IP address, MAC address, phone number, or any other identifier associated with the user device. The analytics server uses this information to identify an account of the user, which may include payment information, recent purchases, credentials, authorized communication channels and devices, saved preferences, and other information (e.g., payment information, size, color, and style preferences determined based on previous purchases and user inputs).

The identifier token may also include an indication of the media element with which the user has interacted. For instance, the analytics server may determine that the user has interacted with the media element by receiving an indication from the webserver, application, and/or the browser extension (e.g., informing the server that the user has clicked on a specific coordinate within the webpage that corresponds to a particular product within a media element). In embodiments where the media element is a video, the analytics server may also receive a timestamp of the video that corresponds to the user's interactions so that the analytics server may identify products displayed in the media element at that time.

The analytics server may receive the above-described data from any combination of the webserver, browser extension, and the application. Therefore, receiving the data discussed in the step 402 is not limited to one feature. For instance, when a user clicks on an image, the application executing locally on the user device may transmit the identifier token to the analytics server. However, metadata associated with the image may be transmitted by the webserver or the browser extension. Alternatively, the local application may communicate with the webserver and/or the browser extension, aggregate all the data discussed herein (a user's identifier and the metadata) and transmit the aggregated data using a single electronic message.

In some embodiments, the analytics server may perform the above-described analysis before the user interacts with the media element. For instance, the webserver may transmit an electronic message to the analytics server identifying all the media elements displayed within the website and their corresponding metadata (indicating the products depicted in each media element and information about the product). As a result, the analytics server may analyze the data associated with the products and generate a list of all the media elements within the websites, products depicted within each media element, and their corresponding information.

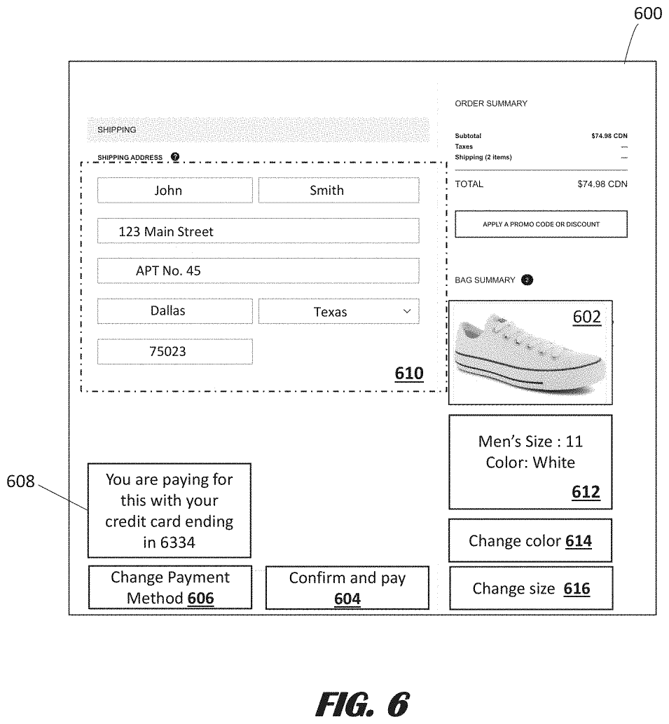

When the user loads the webpage, the analytics server may receive a notification from the browser extension and/or the application installed on the user device. The analytics server may then determine that the webpage has been previously analyzed and includes one or more media elements with “commercial” functionality (e.g., products depicted in the images can be purchased by the user). Optionally, the analytics server may instruct the webserver to display a graphical indicator (e.g., badge, halo) informing the user that the media element depicting the product is selectable for the functionality described herein (e.g., the user can purchase the product). The graphical indicator may include certain limited data associated with the product and/or merchant. For instance, when a cursor hovers over the indicator or the media element, a pop up window may inform the user regarding product description, merchant information, and/or price of the product. The analytics server may provide instructions to the webserver to display the graphical indicator as an overlay to the media element. In another example, a pluggable component (e.g., plug-in software component) may insert a customized overlay that includes the graphical indicator within the software script of the website. An example of the graphical indicator and the user's interactions is illustrated in FIGS. 5-6.

In some embodiments, if the webserver does not transmit metadata associated with the product depicted, the analytics server may capture an image (e.g., screenshot of the video frame interacted by the user or a copy of the image itself) of the media element viewed (and interacted with) by the user. Additionally or alternatively, the application may provide the screenshot to the analytics server. The analytics server may then execute an image-matching protocol and match the product depicted in the media element with known products and images to identify the product depicted within the media element. The analytics server may then query and retrieve data associated with the product within the media element.

At step 404, the analytics server may retrieve payment data and a purchase preference based on the retrieved user identifier and metadata, the purchase preference being extracted from at least one previously completed purchase associated with the user identifier.

The analytics server may analyze the electronic message received from the merchant's webserver to identify various insights and preferences associated with the user. The analytics server may identify the user's preferences based on a user profile. As discussed above, the analytics server may parse and analyze the electronic messages received (e.g., from the webserver, application, and/or the browser extension) to determine the UID. The analytics server may then retrieve a user profile associated with the UID. The user profile may include the user's preferred method of delivery, shipping address, preferred payment method and corresponding data, and other preferences (e.g., size, color).

The user profile may also include insights previously analyzed and extracted by the analytics server. For instance, the user profile may include historical data associated with the user's previous purchases and deliveries. The analytics server may apply (or may have previously applied) various analytical protocols and rules to infer insights from the user's previously completed purchases. For instance, the analytics server may apply a computer model (e.g., machine learning or other algorithmic models) to infer that the user's preferred shoe color is white and preferred shoe style is two-tone because the user has selected two-tone shoes 85% of the time or the user prefers to use a particular credit card when purchasing items that cost more than $100.

The customer profile may also include various rules and regulations that can be applied to identify the user's preferred delivery method. For instance, the user may have previously identified that the user prefers expedited delivery for items purchased from a particular merchant or when purchasing books. In another example, the user may have previously identified that the user prefers drone or bike delivery when purchasing food but prefers automobile delivery when purchasing other items. In yet another example, the user may have previously identified that the customer prefers drone delivery for purchases that are more than $50.

At step 406, the analytics server may generate a message containing transaction attributes corresponding to the payment data and the purchase preference. The analytics server may generate an electronic message (e.g., token) that includes data associated with the selected product within the media element and may also include data associated with the user (e.g., size, color, shipping method and address, and other preferences). The electronic message may include any data necessary to complete a transaction in which the product depicted within the media element is sold to the user.

At step 408, the analytics server may transmit the message to a server hosting the media element, wherein the message initiates a checkout process using at least one of the transaction attributes. The analytics server may transmit the electronic message to the webserver (or a merchant server) along with instructions to initiate a checkout process. For instance, the analytics server may instruct the webserver to generate an order object using the information included in the electric message sent (step 406). Alternatively, the analytics server may generate the order object and transmit the order object to the webserver.

The order object may be code that configure the transaction for a checkout process in accordance with the information included within the message. For instance, the webserver and/or the merchant server may prepopulate various input elements (e.g., size and color) of a checkout page based on the user's preferences identified within the electronic message. The electronic message may also include the user's payment information, such that the merchant can complete the transaction without needing any additional information from the user or the analytics server.

Different websites and webservers execute different checkout processes. Therefore, the methods and systems described herein may provide enough information for the webserver to execute the checkout process itself. For instance, the electronic message generated and transmitted to the webserver includes all (or in some cases as much as possible) information needed for the webserver to facilitate the transaction. As a result, the user is no longer required to manually input various product attributes (e.g., size, color, or style) and/or their payment information. In this way, the analytics server expedites the checkout process.

In some embodiments, initiating a checkout process may comprise adding the product to the user's electronic cart. For instance, when the user interacts with a media element, the analytics server instructs the webserver to add the product depicted within the media element to an electronic cart of the user (or associated with the user's browsing session). This process may be conducted in the background without impeding with the user's shopping experience. For instance, the product may be automatically added to the electronic cart without requiring any input from the user. In some embodiments, as will be described below, the checkout process may direct the user to a third-party server that processes the payment.

In a non-limiting example, the electronic message may instruct the webserver to prefill or prepopulate one or more input elements of a checkout page or automatically submit the purchase preferences and/or the payment data to third party server to facilitate the transaction.

In some embodiments where a payment is initiated from the local application rather than the server, the local application may generate a secure token that includes the user's payment information and may transmit the secure token to the webserver to complete the transaction accordingly.

In some embodiments, the electronic message sent to the webserver may not include the user's confidential payment information. For instance, the analytics server may only send the user's product preferences and shipping address and the analytics server may facilitate the payment separately; for instance, via the application installed on the user device. The analytics server may instruct the application to display a prompt on the user device requesting the user to confirm the transaction. For instance, the analytics server may instruct the application or the browser extension executing on the user's device to send a push notification to the user device or any other pre-authorized user devices. Depending on the purchase amount or other criteria, the server may require additional authentication as well (e.g., second factor authentication). Specifically, the analytics server may display the push notification on a trusted (pre-authorized) user device associated with the user profile (e.g., associated with an identifier of the user).

Using the methods and systems described herein, the user may buy a product simply by interacting with a media element and (optionally) confirming the transaction (e.g., via a browser, application, or via another communication on an electronic device). In one example, upon clicking a media element depicting a product, a confirmation page is presented on the browser or application allowing the user to confirm a prepopulated checkout transaction to complete the purchase. In another example, a user may click on a media element depicting a product to indicate a desire to purchase the product. The analytics server then transmits a push notification to the user's mobile device. The user can complete the purchase by confirming that the user is indeed interested in purchasing the product. The analytics server utilizes the methods discussed herein to ensure that the payment method and purchase preferences of the user is used when selecting attributes of the product (e.g., style, size, and color).

FIG. 5 illustrates a non-limiting example of the analytics server dynamically revising a presentation of one or more products depicted on a website and allowing a user to automatically purchase the product(s). Referring now to FIG. 5, a user may access the website 500. The website 500 may represent a merchant's online store the user can access to order items. However, the methods and systems discussed herein are not limited to merchant websites. For instance, a website may display a product that is commercial in nature (e.g., sold via an entity associated with the website or via a third-party entity) and use the methods discussed herein to allow users to quickly view data associated with the product depicted within an image and/or purchase the product. In another embodiment, the methods discussed herein also apply to a media element displayed on social media platforms and social media applications. For instance, the methods discussed herein may be applied to media elements posted by different social media users, such that viewers can purchases the product depicted within social media posts. Moreover, the methods described herein also apply to other electronic platforms utilizing different visualization methods and modalities, such as mobile applications.

The webserver hosting or otherwise functionally associated with the website 500 may be configured to display images 502-506 where the image 502 depicts a person wearing a pair of shoes, the image 504 depicts a person reading a book, and the image 506 depicts flowers. The user may purchase the pair of shoes, the book, and/or the flowers via a merchant associated with the webserver.

Using the methods and systems discussed herein, the analytics server may determine that the user has accessed the website 500. For instance, the user may be accessing the website 500 using a browser application of their mobile device. An application installed on the user's device may be in direct communication with the analytics server. The mobile application may transmit an identifier of the website 500 to the analytics server (e.g., URL of the website 500), such that the analytics server can identify the webserver hosting the website 500.

The analytics server may use the methods described herein to display the graphical indicators 508, 510, and 512. For instance, the analytics server may generate an overlay that includes the graphical elements 508, 510, and/or 512. The analytics server may then transmit the overlays to the webserver and instruct it to display the overlays. In another example, the analytics server may instruct the webserver to display the graphical elements 508, 510, and/or 512 by transmitting the appropriate code identifying one or more visual attributes of the graphical indicators 508, 510, and/or 512. The analytics server may also indicate a location associated with each graphical indicator. For instance, the analytics server may instruct the webserver to display the graphical indicator 512 near the depicted book.

When a user interacts with a graphical element (e.g., clicks or hovers over a graphical element), the analytics server may instruct the webserver to output data associated with the product depicted in each image. For instance, when the user clicks on the graphical indicator 508, the analytics server may retrieve metadata associated with the shoes depicted in the image 502 indicating information associated with the shoes. For instance, the metadata may indicate a merchant selling the shoes, available colors, available sizes, available styles, and the like. The information may be retrieved directly from the webserver, from the application installed on the user's mobile application, or both. For instance, the mobile application may transmit an indicator of the user (e.g., user's ID or an indicator used to retrieve a user profile) to the analytics server. Additionally, the webserver may transmit a message to the analytics server that indicates an identifier of the shoes depicted within the image 508 (e.g., name of the shoes with their style).

The analytics server may then direct the webserver to display the pop-up window 518 that indicates data associated with the shoes depicted in the image 502. Specifically, the pop-up window 518 indicates that the shoes are men's shoes and provides the price for the shoes. The pop-up window 518 may also include the interactive buttons 514 and 516. When the user interacts with the interactive button, the analytics server directs the mobile device to a website associated with the product, such as a manufacturer of the product. When the user interacts with the interactive button 514, the analytics server causes the webserver to initiate a checkout process by directing the user to the checkout page 600, depicted in FIG. 6.

The analytics server may generate an electronic message using the data received (e.g., user ID), payment data, a purchase preference for the user. That is, the analytics server may generate one or more attributes associated with the user's purchase, such as the user's preferred size, color, style, and the like. The analytics server may also transmit the user's payment information. The analytics server may instruct the webserver to prepopulate one or more input fields of the checkout page 600.

The checkout page 600 may indicate the user's purchase preferences. Specifically, the graphical component 612 may indicate the user's preferences (e.g., indicating that the user would like the shoes in white and in size 11). The checkout page may also include the image 602 that corresponds to the shoes customized per the user's purchase preferences (white and in size 11). The user may change these attributes using the interactive buttons 604 or 616. The checkout page 600 may indicate that the transaction is to be facilitated using the user's pre-saved payment information (graphical element 608). The checkout page 600 may include the interactive button 604 allowing the user to change their payment method.

The checkout page 600 may also include various prepopulated input fields, such as the input fields 610 where the analytics server and/or the webserver have prefilled the user's shipping address based on data retrieved from the user's profile. To complete the transaction, the user can either change one or more attributes of the transaction using various interactive buttons discussed herein or can confirm and pay using the interactive button 604.

Even though the embodiment depicted in FIGS. 5-6 illustrates that the user device is directed to a new page (e.g., the checkout page 600), in some configurations, the user device may not be directed towards a new page. For instance, the checkout input elements and other feature depicted within the checkout page 600 may be a part of the page depicted as the website 500. As a result, the analytics server and/or the webserver may not direct the user to a new page (e.g., checkout page 600) to facilitate the transaction. Specifically, the website 500 may display one or more features of the checkout page 600 itself.

Additionally, the checkout features described herein may still be prefilled as described herein. In some other configurations, the checkout process may be entirely performed via a background process and without involving the user (e.g., requesting the user for their input) or displaying anything. For instance, by initiating or executing the checkout process, the webserver and/or the analytics server may add the product (that has been customized per the user's preferences) to an electronic cart allowing the user to continue shopping/browsing until the user is ready to checkout.

Using the methods and systems described herein, the analytics server can facilitate a transaction whether a product depicted within a media element is properly linked to a merchant website. For instance, even if the media element is not linked to a merchant website, the analytics server can identify the product depicted within the media element, generate an order that is customized for the user, and instruct the webserver to initiate the checkout process.

In an embodiment, a method comprises in response to an interaction with a commerce object of a media element, retrieving, by a processor, a user identifier and metadata associated with a product depicted within the media element, the metadata indicating at least an attribute of the product, the media element displaying a graphical element indicating at least one attribute of the product retrieved from the metadata; retrieving, by the processor, payment data and a purchase preference based on the retrieved user identifier and metadata, the purchase preference being extracted from at least one previously completed purchase associated with the user identifier; generating, by the processor, a message containing transaction attributes corresponding to the payment data and the purchase preference; and transmitting, by the processor, the message to a server hosting the media element, wherein the message initiates a checkout process using at least one of the transaction attributes.

The user identifier may be included within an identifier token received from an application installed on an electronic device displaying the media element.

Initiating the checkout process may comprise directing, by the processor, a user device displaying the media element to a checkout page. Initiating the checkout process may also comprise prepopulating, by the processor, at least one input element of the checkout page using the payment data or the purchase preference.

The processor may further provide, for display on an electronic device displaying the media element, a prompt configured to receive a confirmation associated with purchasing the product.

The prompt may be a push notification displayed on an electronic device associated with the user identifier.

The initiation of the checkout process may comprise adding, by the processor, the product to an electronic cart.

The graphical element may display data associated with the product comprising a merchant offering the product, price for the product, a merchant website, a product name, available colors, available sizes, or available styles.

The media element may be an image or a video.

In another embodiment, a machine-readable storage medium has computer-executable instructions stored thereon that, when executed by one or more processors, cause the one or more processors to perform operations comprising: in response to an interaction with a commerce object of a media element, retrieving a user identifier and metadata associated with a product depicted within the media element, the metadata indicating at least an attribute of the product, the media element displaying a graphical element indicating at least one attribute of the product retrieved from the metadata; retrieving payment data and a purchase preference based on the retrieved user identifier and metadata, the purchase preference being extracted from at least one previously completed purchase associated with the user identifier; generating a message containing transaction attributes corresponding to the payment data and the purchase preference; and transmitting the message to a server hosting the media element, wherein the message initiates a checkout process using at least one of the transaction attributes.

The user identifier may be included within an identifier token received from an application installed on an electronic device displaying the media element.

Initiating the checkout process may comprise directing, by the processor, a user device displaying the media element to a checkout page.

Initiating the checkout process may comprise prepopulating at least one input element of the checkout page using the payment data or the purchase preference.

The instructions may further cause the one or more processors to provide, for display on an electronic device displaying the media element, a prompt configured to receive a confirmation associated with purchasing the product.

The prompt may be a push notification displayed on an electronic device associated with the user identifier.

The initiation of the checkout process may comprise adding the product to an electronic cart.

The graphical element may display data associated with the product comprising a merchant offering the product, price for the product, a merchant website, a product name, available colors, available sizes, or available styles.

The media element may be an image or a video.

In another embodiment, a computer system comprises a server having a processor, the server in communication with a computing device associated with a graphical user interface, the server configured to: in response to an interaction with a commerce object of a media element, retrieve a user identifier and metadata associated with a product depicted within the media element, the metadata indicating at least an attribute of the product, the media element displaying a graphical element indicating at least one attribute of the product retrieved from the metadata; retrieve payment data and a purchase preference based on the retrieved user identifier and metadata, the purchase preference being extracted from at least one previously completed purchase associated with the user identifier; generate a message containing transaction attributes corresponding to the payment data and the purchase preference; and transmit the message to a server hosting the media element, wherein the message initiates a checkout process using at least one of the transaction attributes.

The user identifier may be included within an identifier token received from an application installed on an electronic device displaying the media element.

The foregoing method descriptions and the process flow diagrams are provided merely as illustrative examples and are not intended to require or imply that the operations of the various embodiments must be performed in the order presented. The operations in the foregoing embodiments may be performed in any order. Words such as “then,” “next,” etc., are not intended to limit the order of the operations; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The operations of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

1. A method comprising:
in response to an interaction with a commerce object of a media element, the interaction comprising a hover event associated with the media element, retrieving, by a processor, a user identifier and metadata associated with a product depicted within the media element, the metadata indicating at least an attribute of the product, the media element displaying a graphical element indicating at least one attribute of the product retrieved from the metadata;
retrieving, by the processor, payment data and a purchase preference based on the retrieved user identifier and metadata, the purchase preference being extracted from at least one previously completed purchase associated with the user identifier;
generating, by the processor, a message containing transaction attributes corresponding to the payment data and the purchase preference;
transmitting, by the processor, the message to a server hosting the media element, wherein the message initiates a checkout process using at least one of the transaction attributes; and
providing, by the processor for display on an electronic device displaying the media element, a prompt configured to receive a confirmation associated with purchasing the product.

2. The method of claim 1, wherein the user identifier is included within an identifier token received from an application installed on the electronic device displaying the media element.

3. The method of claim 1, wherein initiating the checkout process comprises:
directing, by the processor, the electronic device displaying the media element to a checkout page.

4. The method of claim 3, wherein initiating the checkout process comprises:
prepopulating, by the processor, at least one input element of the checkout page using the payment data or the purchase preference.

5. (canceled)

6. The method of claim 1, wherein the prompt is a push notification displayed on the electronic device.

7. The method of claim 1, wherein initiation of the checkout process comprises:
adding, by the processor, the product to an electronic cart.

8. The method of claim 1, wherein the graphical element displays data associated with the product comprising a merchant offering the product, price for the product, a merchant website, a product name, available colors, available sizes, or available styles.

9. The method of claim 1, wherein the media element is an image or a video.

10. A non-transitory machine-readable storage medium having computer-executable instructions stored thereon that, when executed by one or more processors, cause the one or more processors to perform operations comprising:
in response to an interaction with a commerce object of a media element, the interaction comprising a hover event associated with the media element, retrieving a user identifier and metadata associated with a product depicted within the media element, the metadata indicating at least an attribute of the product, the media element displaying a graphical element indicating at least one attribute of the product retrieved from the metadata;
retrieving payment data and a purchase preference based on the retrieved user identifier and metadata, the purchase preference being extracted from at least one previously completed purchase associated with the user identifier;
generating a message containing transaction attributes corresponding to the payment data and the purchase preference;
transmitting the message to a server hosting the media element, wherein the message initiates a checkout process using at least one of the transaction attributes; and
providing, for display on an electronic device displaying the media element, a prompt configured to receive a confirmation associated with purchasing the product.

11. The machine-readable storage medium of claim 10, wherein the user identifier is included within an identifier token received from an application installed on the electronic device displaying the media element.

12. The machine-readable storage medium of claim 10, wherein initiating the checkout process comprises:
directing, by the processor, the electronic device displaying the media element to a checkout page.

13. The machine-readable storage medium of claim 12, wherein initiating the checkout process comprises:
prepopulating at least one input element of the checkout page using the payment data or the purchase preference.

14. (canceled)

15. The machine-readable storage medium of claim 10, wherein the prompt is a push notification displayed on the electronic device.

16. The machine-readable storage medium of claim 11, wherein initiation of the checkout process comprises:
adding the product to an electronic cart.

17. The machine-readable storage medium of claim 10, wherein the graphical element displays data associated with the product comprising a merchant offering the product, price for the product, a merchant website, a product name, available colors, available sizes, or available styles.

18. The machine-readable storage medium of claim 10, wherein the media element is an image or a video.

19. A computer system comprising:
a server having a processor, the server in communication with a computing device associated with a graphical user interface, the server configured to:
in response to an interaction with a commerce object of a media element, the interaction comprising a hover event associated with the media element, retrieve a user identifier and metadata associated with a product depicted within the media element, the metadata indicating at least an attribute of the product, the media element displaying a graphical element indicating at least one attribute of the product retrieved from the metadata;
retrieve payment data and a purchase preference based on the retrieved user identifier and metadata, the purchase preference being extracted from at least one previously completed purchase associated with the user identifier;
generate a message containing transaction attributes corresponding to the payment data and the purchase preference;
transmit the message to a server hosting the media element, wherein the message initiates a checkout process using at least one of the transaction attributes; and
provide, for display on the computing device, a prompt configured to receive a confirmation associated with purchasing the product.

20. The computer system of claim 19, wherein the user identifier is included within an identifier token received from an application installed on an electronic the computing device displaying the media element.
